(19) United States
(12) Patent Application Publication
(10) Pub. No.: US 2007/0005493 A1
(43) Pub. Date: Jan. 4, 2007

(54) Sponsor-manager reconciliation in handling of custodian transactions

(76) Inventors: Amy Kandravy, Norwell, MA (US); Charles R. Smith III, Hoboken, NJ (US); Michele Pierdinock, Hoboken, NJ (US); Donna Figlik, Chicago, IL (US); Lorraine Giordano, Hoboken, NJ (US); Simon Gershon, Merrick, NY (US); Ann Harding, Maplewood, NJ (US); William McKinney, Westfield, NJ (US)

Correspondence Address: SUTHERLAND ASBILL & BRENNAN LLP, 999 PEACHTREE STREET, N.E., ATLANTA, GA, 30309, US

(21) Appl. No.: 11/377,803

(22) Filed: Mar. 16, 2006

Related U.S. Application Data
(63) Continuation-in-part of application No. 11/169,018, filed on Jun. 29, 2005.

(51) Int. Cl. G06Q 40/00

(52) U.S. Cl. 705/39

(57) ABSTRACT

Methods and a system for performing automatic acceptance of an alteration of an investment account transaction. Alterations are made to a first view of the investment account transaction and, based on one or more applicable rules, a second view of the investment account transaction is updated to reflect the alterations made to the first view. The one or more applicable rules control the acceptance by the second view of the alterations made to the first view.

### RELATED APPLICATION DATA

The present application is a continuation-in-part of U.S. patent application Ser. No. 11/169,018, filed on Jun. 29, 2005, currently pending, the contents of which are incorporated by reference as if set forth fully herein.

### FIELD OF THE INVENTION

The present invention relates to investment portfolio management, and more particularly to systems and methods for reconciling investment portfolio records.

### BACKGROUND OF THE INVENTION

FIG. 1 depicts a conventional portfolio management system architecture in which an individual investor 10 has a single investment account (IA) with a sponsor 14. A sponsor 14 may be a brokerage firm, and for the purposes of this document, these terms are used interchangeably. Investment account data is maintained in a database 26A of an automated sponsor portfolio management system (SPMS) 26 utilized by the sponsor 14. The sponsor 14 also opens a custodial client account (CCA) at a custodian firm 16 which is associated with the IA. The custodial client account is entered into a database 28A of the custodian management system (CMS) 28 conventionally utilized by the custodian firm 16, and typically associated with the tax identifier, i.e., tax ID, of the investor 10. The official and formal records for the IA will be the records for the CCA, as maintained by the custodian firm 16.

Oftentimes a sponsor 14 leverages a money manager 20 to actually manage an IA such that the IA will have an investment style defined by the money manager 20. It is possible for a sponsor 14 to leverage more than one money manager 20 to manage an IA, but here only one money manager 20 is shown for ease in understanding. A money manager 20 opens a managed trading account, which will sometimes be referred to as an MTA, corresponding to the IA. The trading account records for each MTA are entered into a database 30A of an automated money manger portfolio management system (MMPMS) 30 conventionally utilized by a money manager 20.

Some investment accounts are broken into multiple trading accounts (TAs) which may be handled by one or more money managers 20. In such a case, the custodian firm 16 maintains a unique CCA for each TA. For simplicity's sake, it will be assumed that in the present example the IA is not divided into multiple TAs, though it certainly could be.

As the money manager 20 makes decisions on the managed trading account, associated trade orders, including orders to buy securities or sell securities in a particular company, are initiated by the money manager 20 and forwarded to the sponsor 14. Based on the issued trade orders, the sponsor 14 executes the trades in fulfillment of the orders. In this regard, the sponsor 14 will, through its trading desk, execute the buys and the sells to actually perform the ordered trades.

After fulfillment of one or more orders, the sponsor 14 forwards a file representing the executed buys and sells to the custodian 16. Based on the information represented in the forwarded file, the custodian 16 records the trades in the books and records for the custodial trading account. It should be stressed that the “authority book of record” for the IA is at the custodian 16, not at the sponsor 14, or the money manager 20.

Information, in the form of a file representing the information associated with the CCA and often referred to as authority data, flows from the custodian 16 to the sponsor 14, and then optionally from the sponsor 14 to the money manager 20. Accordingly, both the IA maintained by the sponsor 14 and the MTA maintained by the money manager 20 attempt to shadow the CCA maintained by the custodian 16. The custodian 16 sends the authority data, typically in batch files, to the sponsor 14 periodically, such as nightly, weekly, or monthly. Authority data can include, but is not limited to, one or more of trades, book values, cash positions, and/or security positions.

After the sponsor 14 receives the authority information a reconciliation process is invoked by the SPMS 26. Depending upon the reconciliation process used by the sponsor 14, the brokerage firm records of the IA in database 26A may be altered. Many different reconciliation processes may be practiced by the sponsor 14 and/or the money manager 20.

At some point, which may be a function of a time or an event, the sponsor 14 sends some, but not necessarily all, of its data, which may reflect reconciliation against received custodian data, to the money manager 20. This might be done upon completion of sponsor reconciliation, or upon a predetermined schedule. The MMPMS 30 then invokes another reconciliation process. As with the sponsor 14, depending upon the reconciliation process practiced by the money manager 20, the money manager records of the MTA in database 30A may be altered.

The existing data flows, plurality of reconciliation options, and differences between the sponsor and money manager result in significant problems, including data being out of sync between the sponsor 14 and the money manager 20. Data sync problems arise in situations in which the sponsor 14 and the money manager 20 do not work off of the same authority data, i.e., the sponsor 14 massages the authority data in some manner before sending it to the money manager 20. Also, the money manager 20 may receive authority data that is not fully “clean”. That is, the money manager 20 may receive entries that later have to be corrected at the sponsor 14, but the corrected entries are not forwarded to the money manager 20.

Another problem with existing reconciliation options is that manual exception management between the sponsor 14 and the money manager 20 is time-consuming and tedious. Introduced above, each entity has its own database for storing account information. To fully research an exception, the money manager 20 must either access the sponsor 14 database 26A, or request the sponsor 14 to do so, or vice versa if the exception occurs during sponsor 14 reconciliation. Also, the sponsor 14 and the money manager 20 may use different transaction codes and/or use different reconciliation options, adding to the difficultly of exception management. That is, it may be difficult for the two entities to identify records for the same transaction.

What is needed is a reconciliation process that overcomes the deficiencies of the prior art.

### SUMMARY OF THE INVENTION

According to an embodiment of the invention, there is disclosed a method for the approval of an alteration of an investment account transaction that includes storing in a data repository a first record of a transaction associated with a first entity and a second record of a transaction associated with a second entity. The data repository is accessible by both the first and second entity. If the first record of the transaction is altered, an applicable rule is identified and, if the rule is satisfied, the second record of the transaction is altered to conform to the first record.

According to another embodiment of the invention, there is disclosed a method for performing automatic acceptance of an alteration of an investment account transaction. If an alteration is made to a first view of the investment account transaction, a second view of the investment account transaction will be updated to reflect the alterations made to the first view in an applicable rule is satisfied. The applicable rule controls the automatic acceptance by the second view of the alterations made by the second view.

According to yet another embodiment of the invention, there is disclosed a system for performing automatic acceptance of an alteration of an investment account transaction. The system includes a memory and a processor. The memory is configured to store a first view of an investment account transaction, a second view of an investment account transaction, and one or more applicable rules associated with the automatic acceptance of an alteration to the first view by the second view. The processor is in communication with the memory and includes program logic that performs the steps of altering the first view of the investment account transaction and updating the second view of the investment account transaction to reflect the alterations made to the first view if the one or more applicable rules are satisfied.

Aspects of the invention described below apply to each of the method for the approval of a reconciliation of an investment account transaction, the method for performing automatic acceptance of an alteration of an investment account transaction, and the system for performing automatic acceptance of an alteration of an investment account transaction. According to one aspect of the present invention, the first record, or alternatively the first view, is associated with a sponsor of an investor with whom the investment account is associated, and the second record, or alternatively the second view, is associated with a money manager that directs the transacting of at least a portion of the investment account. According to an alternative aspect of the present invention, the first record, or alternatively the first view, is associated with a money manager that directs the transacting of at least a portion of the investment account; and the second record, or alternatively the second view, is associated with a sponsor of an investor with whom the investment account is associated.

According to another aspect of the present invention, the method or system further receives additional information relating to an investment account transaction. This information may be received form a third entity and may be in the form of a third record. Additionally, this information may be authoritative data for a particular investment account transaction. This additional information may be received from a custodian that maintains the authority book of record for the investment account.

According to yet another aspect of the present invention, the altering of the first record, or alternatively the first view, of an investment account transaction is performed in order to conform the first record or first view to the received additional information. The alterations to the first record, or alternatively the first view, may be based on the execution of one of (i) a post only reconciliation process, (ii) a reconcile only reconciliation process, (iii) a reconcile and post reconciliation process, (iv) a reconcile and adjust reconciliation process, (v) an ignore reconciliation process, and (vi) a pend reconciliation process.

According to another aspect of the present invention, the altering or updating of the second record, or alternatively the second view, on an investment account transaction is an alteration to one of (i) a share price of a security involved in a transaction, (ii) a total monetary value of a security transaction, (iii) a total number of shares involved in a security transaction, (iv) a date on which a security transaction occurred, and (v) a time at which a security transaction occurred.

According to yet another aspect of the present invention, the applicable rule or rules may be associated with at least one entity, wherein the at least one entity is associated with the second record, or alternatively the second view, of an investment account transaction. According to another aspect of the invention, the applicable rule or rules may be associated with the transaction type of the investment account transaction. According to yet another aspect of the invention, the applicable rule or rules may be associated with a security involved in the investment account transaction. According to a further aspect of the invention, the applicable rule or rules may be associated with one or more investment accounts.

According to another aspect of the invention, the applicable rule or rules are identified by selecting from a plurality of rules which may apply to the investment transaction. The applicable rule or rules are selecting based on relative prioritization of the plurality of rules which may apply to the investment transaction.

According to yet another aspect of the invention, an indicator of the altering of the second record, or alternatively the second view, of an investment account transaction may be stored. Additionally, at least one of the first entity and the second entity, which are associated respectively with the first and second record, or alternatively the first and second views, may be notified of the alteration made to the second record or view.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a conventional portfolio management system architecture.

FIG. 2 depicts a portfolio management system architecture, according to an illustrative embodiment of the present invention.

FIG. 3 depicts the movement and storage of portfolio data, according to an illustrative embodiment of the present invention.

FIG. 4 is a flow chart depicting processing, according to an illustrative embodiment of the present invention.

FIG. 5 depicts a portfolio management system, according to an illustrative embodiment of the present invention.

FIG. 6 depicts the movement and storage of portfolio data, according to an illustrative embodiment of the present invention.

FIG. 7 is a flow chart depicting processing, according to an illustrative embodiment of the present invention.

### DETAILED DESCRIPTION OF THE INVENTIONS

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Various types of reconciliation processes may be performed by the present invention. These processing options may include, but are not limited to the following: “post-only”; “reconcile-only”; “reconcile-and-adjust”; “reconcile-and-post”; “ignore”; and “pend”. Additionally, the scope of the various reconciliation processes may be limited by one or more business rules, as described in greater detail below. For the post-only option, received unique authority data within the scope of the one or more business rules is accepted and entered into the receiving entity's database. For entities that practice “post-only”reconciliation, the receiving entity accepts the received data without question (it may perform a duplicate entry check to ensure that the same entry is not posted twice, i.e., that the data is unique). This type of reconciliation is appropriate for those transactions that do not originate at the receiving entity, yet must be reflected in the receiving entity's database. Examples include an interest posting which is not calculated and entered by the receiving entity, and trade reporting for certain instruments when the trades originate outside of the receiving entity.

In the “reconcile-only” option, received unique authority data, which is within the scope of the one or more business rules, and for which a prior entry has been made in the receiving database, is processed. The authority data from the upstream source is compared to the prior entry, and any differences that exceed a tolerance level are reported to a human operator for examination and resolution. Such a discrepancy is known as an exception. No changes are automatically made to the receiving entity's database for any reported exceptions. Typically, the receiving entity typically may, as desired, adjust tolerance levels. It is even possible for a receiving entity to adjust a tolerance level to zero, in which case any deviations from the prior entry would be reported as an exception, or set to infinity, in which case any deviation would be ignored. This type of reconciliation is appropriate for transactions that originated with the receiving entity and have a high likelihood of being accurate. One example is a trade transaction generated by the receiving entity.

In the “reconcile-and-adjust” option, similar to the “reconcile-only” option, received unique authority data within the scope of the one or more business rules, and for which a prior entry has been made in the receiving database, is processed. Received authority data is compared to the corresponding prior entry. If a difference within a tolerance level is detected, an adjustment is automatically made to the prior entry to bring it in line with the received entry. It should be noted that a record remains of the original, prior entry. If the difference exceeds the tolerance level, it is merely reported in a reconciliation report. As with the reconcile-only option, typically tolerance levels may, as desired, be adjusted or ignored. If ignored, all differences will result in an automatic adjustment of the prior entry. This type of reconciliation is appropriate for certain types of trade and corporate action transactions, as well as pending withdrawals and deposits.

Similar to the “reconcile-and-adjust” option, in the “reconcile-and-post”option, received unique authority data within the scope of the one or more business rules, and for which a prior entry has been made in the receiving database, is processed. The received authority data is compared to the corresponding prior entry. If a difference within a tolerance level is detected, the prior entry is replaced with the received data. Thus, no record remains of the original, prior entry in the receiving database, although it is possible that a copy of the prior entry may be stored elsewhere. If the difference exceeds the tolerance level, it is reported in a reconciliation report. The tolerance level may be, as desired, ignored or adjusted. If ignored, any difference simply causes the received entry to replace the original, prior entry. This type of reconciliation is appropriate for transactions, which may or may not have been initiated by the receiving entity, for which the transmitting entity is considered acceptably authoritative. Examples of transactions types include dividends, fees, and commissions.

In the ignore option, received authority data within the scope of the one or more business rules is neither reconciled against, nor entered into, the receiving entity's database, or in any way causes that database to be modified. This option is typically set for certain types of transactions that are irrelevant to the receiving entity's system.

In the pend option, received authority data within the scope of the one or more business rules is entered into the database of the receiving entity in a limbo status. That is, this authority data is not yet finally posted and does not affect any other stored data. Typically, there is a subsequent human review of such pending transactions before a final posting is made. Upon review, a pending transaction might be finally posted as received, or may result in an adjustment to a prior entry.

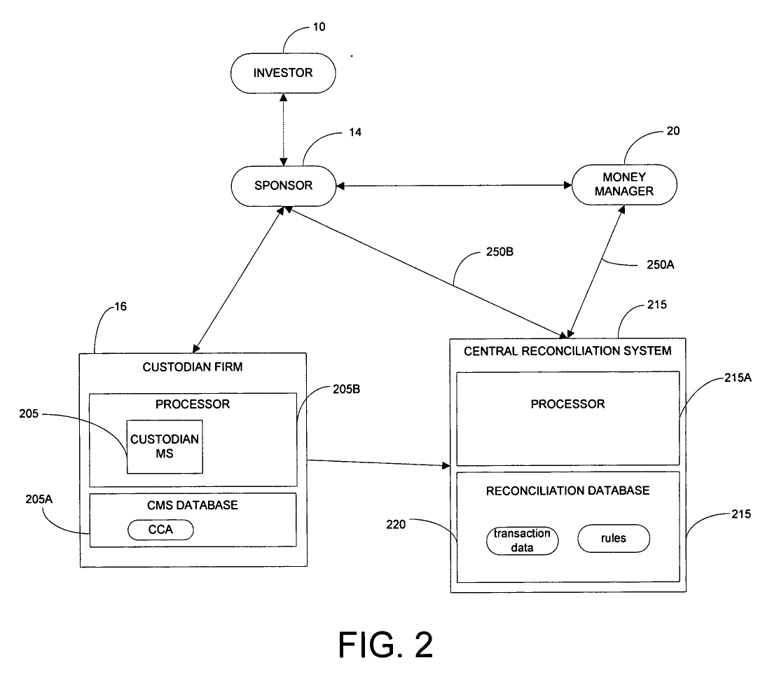

FIG. 2 depicts a portfolio management system architecture in accordance with a first illustrative embodiment of the present invention. As shown, an individual investor 10 opens an investment account (IA) with a sponsor 14, also referred to as a brokerage firm. Similar to the discussion above, a custodian client account (CCA) is opened at the custodian firm 16. The custodian firm 16 is represented by a custodian management system (CMS) 205. The custodian client account is stored in a CMS database 205A. The CCA is maintained by the CMS 205 as the authority of record for all transactions associated with the IA. The architecture of FIG. 2 also includes at least one money manager 20, which is associated with at least one MTA managed by a MMPMS (not shown). As will be appreciated, more than one money manager may participate in the present invention, in which case each may be represented by a unique MMPMS.

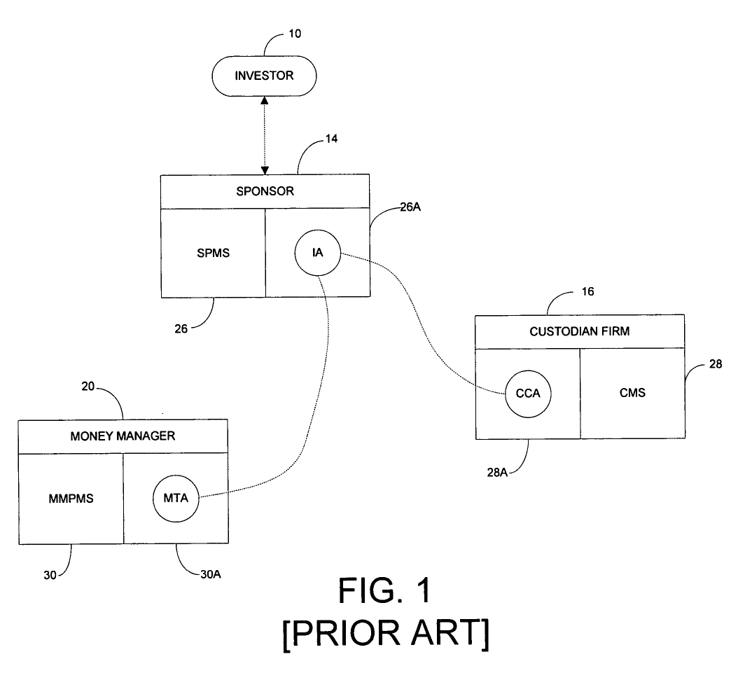

As also shown, the FIG. 2 architecture also includes a central reconciliation system (CRS) 215 serving both the sponsor 14 and the money manager 20, and which includes a reconciliation database 220 that is accessible by both the SPMS (not shown) and the MMPMS (not shown). Thus, the CRS 215 replaces at least portions of the prior art SPMS 26 and MMPMS 30. The reconciliation database 220 is accessible by both the sponsor 14 and the money manager 20. The reconciliation database 220 stores data representing the IA and replaces the prior art databases associated with the sponsor 14 and money manager 20, described above. Thus, different than the architecture shown in FIG. 1 and described above, the broker firm 14 and the money manager 20 are not required to maintain individual repositories of transaction data, or even individual management systems. The CRS 215 could be located at the sponsor 14, the money manager 20, or possibly even elsewhere, such as at a service provider (not shown in the figures).

The CRS 215 is executed by processor 215A which is configured (i.e., programmed) with the logic necessary to perform various functions associated with reconciliation, to be discussed further below. It should be noted that processor 215A could, as desired, perform additional functions. The CMS 205 is executed by processor 205B and is completely distinct from the CRS 215.

The reconciliation database 220 stores transaction data for the IA as well as business rules to be discussed further below. Thus, different than the conventional systems described above, the sponsor 14 and the money manager 20 are not required to maintain repositories of transaction data. Each of the sponsor 14 and money manager 20 is in communication with the CRS 215 via a communication link. The money manager 20 communicates with the CRS 215 via communication link 250A, and the sponsor 14 communicates with the CRS 215 via communication link 250B.

Because the sponsor 14 and money manager 20 share the reconciliation database 220, they may agree to the transaction types to be included in the reconciliation database 220 and the type of reconciliation process to be utilized for each included transaction type. These business rules, as well as others, are a part of the logic that drives the operation of processor 215A of the CRS 215.

Various types of reconciliation processing options can be performed by the CRS 215. These reconciliation options include, but are not limited to, “post-only”; “reconcile-only”; “reconcile-and-adjust”; “reconcile-and-post”; “ignore”; and “pend”. The reconciliation process performed may be limited to a particular scope or subset of the data received by the CRS 215. In other words, a particular reconciliation may be limited to a particular subset of data by the business rules controlling the reconciliation.

As desired and/or necessary, business rules can be partially, or completely, changed by the parties. As such, the stored business rules are configurable to reflect changes in the agreement between the sponsor 14 and the money manager 20. Introduced above, business rules are preferably stored in association with the reconciliation database 220. However, as desired, they could be stored elsewhere for access by the processor 215A.

It should be noted that the sponsor 14 and money manger 20 could, as desired, establish differing rules dependent upon the identity of a custodian from whom authority data will be received, and/or the identity of an investor with whom authority data is associated. Further, it should also be noted that the sponsor 14 will more than likely be associated with multiple money managers. In such a case, the sponsor 14 may establish, as desired, unique rules with each money manager with which the sponsor 14 is associated. Still further, business rules could vary based upon a program with which an IA is associated, the identity of a sponsor (client), as well as the investment strategy or investment style. In fact, varying levels of business rules can be established in which conflicts between the business rules are resolved according to a precedence order established for the levels of business rules. These levels of business rules may include, in ascending order of precedence, client level business rules, program level business rules, strategy level business rules, style level business rules and account level business rules. An account level business rule applies only to a specific individual MTA. A style level business rule applies to a group of accounts which contain the same mix of assets and are managed by the same money manager 20. A strategy level business rule applies to a group of accounts managed in accordance with the same investment objective by one or more money managers 20. A program level business rule applies to a group of accounts that are associated with a product offering to investors, where the product offering may encompass multiple investment strategies. Finally, a client level business rule applies to all accounts associated with a particular client or sponsor 14 of a money manager 20, where a client may encompass multiple programs. It will be understood that other levels of business rules may be established as necessary and that the precedence order of business rules may be modified.

A particular business rule may be associated with one or more of the levels described above. A business rule may also be associated with or scoped by a transaction type or by the security involved. The transaction type or security may be used in conjunction with a business rule level to define a particular business rule. For instance, a business rule that applies to a “buy” transaction may be defined at a client level. Alternatively, a business rule that applies to shares of IBM stock may be defined at a strategy level.

Other business rules, established by the sponsor 14 and the money manager 20, are directed to authorization requirements. As discussed above, a particular reconciliation option, agreed to by the parties, might result in changes to data already stored in the reconciliation database 220, or even to received authorization data. Also, either the sponsor 14 or the money manager 20 might desire, for whatever reason, to manually alter stored data. In view of possible changes, the parties may agree as to whether either, or both, must approve of a change, as well as establishing primary and secondary ownership of the data. Ownership agreements can be applied the same to all data, or can be, as desired, applied on a granular level, such as by transaction type. Ownership defines the ordering of application of business rules and conflict-resolution precedence.

Yet other business rules are directed to tolerance levels. Potentially different than the above rules, tolerance rules are set individually by the sponsor 14 and the money manager 20. A tolerance rule dictates whether data having a value that varies from an expected value by a certain number of units will be automatically approved by the CRS 215 for the entity associated with the rule, or held in a pending state until approved by the entity associated with the rule (either the sponsor 14 or the money manager 20). Tolerance limits may be established in any of multiple unit types, including days, percentage, cost/price, etc. These rules may, as desired, vary according to transaction type.

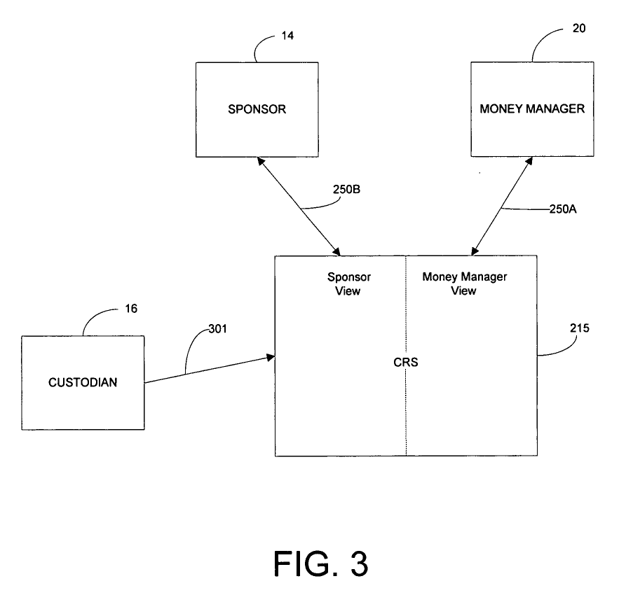

FIG. 3 is a simplified depiction of the movement, storage, and availability of authority data in accordance with a first illustrative embodiment of the present invention. As shown, the custodian 16 transmits authority data directly to the CRS 215, via communication link 301, instead of to the sponsor 14 as in the prior art. The transmission of authority data is periodic and maybe in the form of batch files. However, as desired, authority data could be transmitted to the CRS 215 on an ad hoc basis and/or in a form other than batch files. The CRS processor 215A executes one or more reconciliation processes upon receipt of the authority data. The results of reconciliation are stored in the reconciliation database 220 and may be immediately available for access by the sponsor 14 via communication link 250B and the money manager 20 via communication link 250A. Thus, the sponsor 14 has a view into the reconciliation database 220, and the money manager 14 also has a view into the reconciliation database 220. It should be noted that, as desired, the brokerage firm view and the money manager view may be different, in that one party may be able to view certain data that the other party cannot.

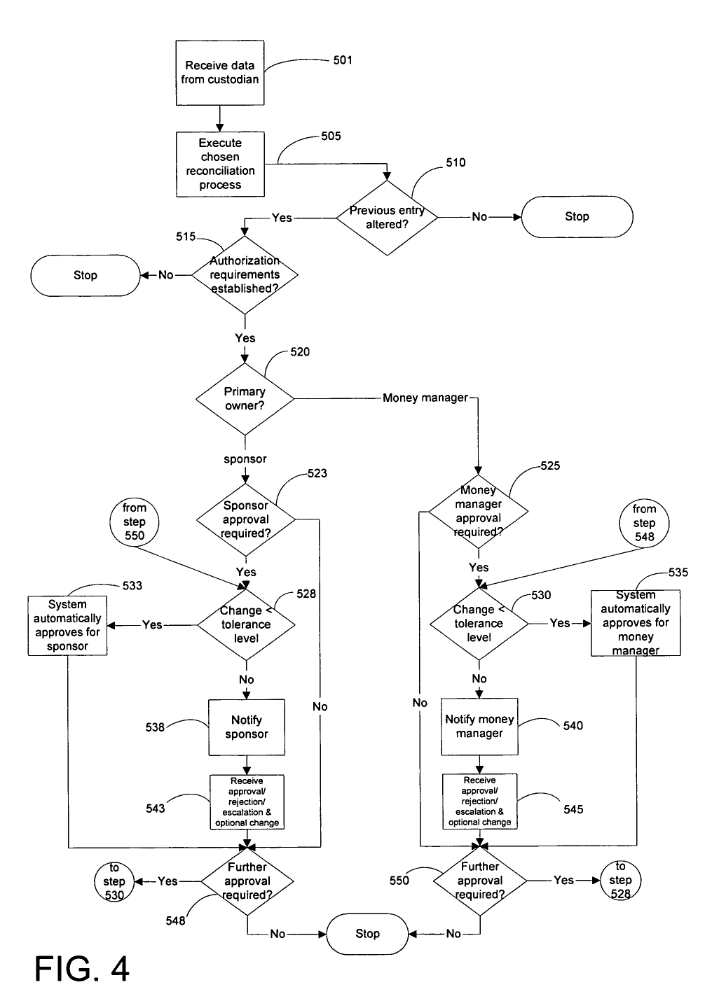

FIG. 4 is a logic diagram depicting the approval portion of an agreed upon reconciliation process according to a first embodiment of the present invention to be followed when a previous entry to the reconciliation database 220 is to be altered based upon an executed reconciliation process. At step 501 the CRS 215 receives authority data from the CMS 205. Upon receipt of the authority data the CRS processor 215A executes the agreed upon reconciliation process upon at least a portion of the received authority, step 505. At step 510 the processor 215A determines if authority data previously stored in the reconciliation database 220 has been altered by the executed reconciliation process. If not, operations stop. If so, operations continue with step 515 in which the processor 215A determines if any authorization requirements have been established by either the money manager 20 or the sponsor 14. That is, the processor 215A determines if any authorization requirement rules are stored. If the determination of step 515 is negative, operations stop.

If it is determined in step 515 that authorization rules have been established, operations continue with step 520 in which the processor 215A determines the primary owner of the reconciled authority data. If the primary owner is determined to be the money manager 20, operations continue with step 525, and if the primary owner is determined to be the sponsor 14, operations continue with step 523. That is, the precedence of established rules is determined based upon the entity having primary ownership of the authority data.

If at step 520 it is determined that the sponsor 14 has primary ownership of the authority data, operations continue with step 523 in which processor 215A determines if authorization requirements have been established by the sponsor 14 for the instant type authority data. If not, operations continue with step 548, to be discussed further below. If so, at step 528, the processor 215A retrieves the sponsor 14 established tolerance rule for the instant type authority data and determines if the alteration, which might be an alteration due to an escalation, to be discussed further below, to the stored authority data is less than the established tolerance level. If so, operations continue with step 533 in which the processor 215A automatically approves the alteration for the sponsor 14. Operations then continue with step 548, to be discussed below.

If at step 528 it is determined that the alteration exceeds the established tolerance level, operations continue with step 538 in which the sponsor 14 is notified of the alteration. At step 543, following step 538, the processor 215A receives from the sponsor 14 either an approval of the alteration, a rejection of the alteration, or an escalation and optional change of the alteration.

In an escalation and optional change, an entity whose approval is being sought for an alteration may, as necessary and/or desired, counter with an alteration proposal resulting from that entity's own research. Following step 543 operations continue with step 548 in which the processor 215A determines if further approval of an alteration (which could result from an escalation) is necessary, i.e., whether the money manager 20 must approve. If not, operations stop. If it is determined that the money manager 20 must approve, operations continue with step 530.

Similar to step 528, at step 530, the processor 215A determines if the alteration is less than a money manager 20 established tolerance level. If so, the processor 215A automatically approves the alteration at step 535. Thereafter, operations continue with step 550, to be discussed further below.

If at step 530 the processor 215A determines that the alteration is not less than the money manager 20 established tolerance level, operations continue with step 540, similar to step 538, in which the money manager 20 is notified of the alteration. At step 545, similar to step 543, a money manager 20 response is received by the processor 215A. The response could be an approval, a rejection, or an escalation and optional change to the alteration. At step 550 the processor 215A determines if further approval is required, i.e., by the sponsor 14. If so, operations continue with step 528. If not, operations end.

If in step 520 it is determined that the primary owner of the authority data is the money manager 20, operations continue with step 525. At step 525 the processor 215A determines if authorization requirements have been established by the money manger 20 for the instant type authority data. If not, operations continue with step 550, discussed above. However, if the money manager 20 has established authorization requirements, operations continue with step 530, also discussed above. The remaining processing, i.e., steps 530 through 550, will be understood from the discussion above.

As an example of the technique provided by the present invention, the reconciliation of a ‘buy equity’ transaction will be discussed. In this example, the sponsor 14 and the money manager 20 agree that the reconciliation process will be reconcile-and-post, that any changes resulting from a reconciliation of a ‘buy equity’ transaction will require the authorization of both parties, and the sponsor 14 has primary ownership, while the money manager 20 has secondary ownership. Also, the sponsor 14 establishes a threshold level of $1.00 for ‘buy equity’ transactions, while the money manager 20 establishes a threshold of $0.01.

The sponsor 14 orders a purchase of 100 shares of IBM stock at $90.00/share. The sponsor 14 transmits this information to the CRS 215 where processor 215A causes this information to be stored in the reconciliation database 220. When executed, 99 shares of IBM at $89.00/share are actually purchased. The CMS 205 transmits authority data reflecting the actual trade to the CRS 215.

At some point after receipt of the authority data, the processor 215A executes the reconcile-and-post process (as the chosen preference). As a result of this processing, the prior “buy 100 shares of IBM at $90.00/share” is replaced with “buy 99 shares of IBM at $89.00/share”. The processor 215A determines, based upon the stored business rules, that both the sponsor 14 and the money manger 20 must approve a change to the prior entry. As the primary owner, the sponsor 14 must approve first.

The processor 215A then accesses the stored tolerance level of the sponsor 14 to determine if an automatic system approval of the alteration can be made. Because the change exceeds the stored threshold, the processor 215A notifies the sponsor 14 of the change. Introduced above, an approving entity can either accept a change, reject a change, or escalate a change. If a change is rejected or escalated, the reviewing entity may counter with a proposal resulting from that entity's own research. In the instant example, the sponsor 14 rejects the reconciliation change and proposes, based upon its own research, an entry for “buy 101 shares of IBM at $101.00/share.”

Because the authorization requirements indicate that the money manager 20, as the secondary owner, must also approve any reconciliation-associated change, the processor 215 examines the brokerage firm's change against the money manager's stored tolerance level for automatic system approval. Because the proposed change exceeds the money manager's threshold, the processor 215A notifies the money manager 20 of the proposed change. As above, the money manager 20 could approve, reject, or escalate the change. However, as the secondary owner, dependent upon agreement between the sponsor 14 and the money manager 20, the money manager may have no, or limited, ability to suggest a counter proposal.

It should be noted that the money manager 20 and sponsor 14 may, as desired, engage in out-of-band interaction to come to agreement on the change proposed by the sponsor 14. However, as long as both parties have not approved of a change which requires approval of both, that associated transaction will appear on exception reports generated by the CRS processor 215A, even though the initial reconciliation process has been completed.

In this example, the money manager 20 and sponsor 14 are engaged in out-of-band interaction on this issue. After out-of-band interaction is completed, the money manger 20 accepts the change proposed by the sponsor 14, and the authorization requirements are thusly fulfilled. Thereafter, the change will no longer show up on exception reports, although preferably the processor 215A will retain a history of the exception and how it was handled by the CRS 215.

While it may be desirable for the sponsor 14 and money manager 20 to agree on a single reconciliation process, resulting in a common specific modification to each internal view in the reconciliation database 220, it is not necessary. According to another embodiment of the present invention, the central reconciliation system 215 supports maintaining separate values for each of the sponsor 14 and the money manager 20. The maintenance of separate values can be accomplished by maintaining separate records within a single database for each of the sponsor 14 and the money manager 20. Alternatively, different access rights to a single database having multiple values associated with both the sponsor 14 and the money manager 20 can be created, resulting in the sponsor 14 and money manager 20 having different internal views of the reconciliation database 220. It will also be understood that a separate database may be maintained for each of the sponsor 14 and the money manager 20.

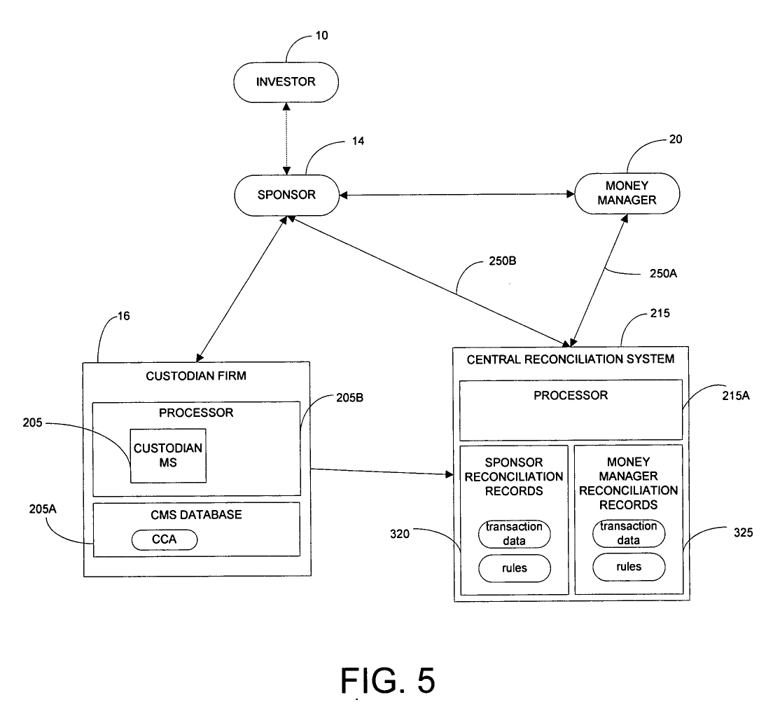

FIG. 5 depicts a portfolio management system architecture in accordance with a second illustrative embodiment of the present invention. Similar to the first embodiment, an individual investor 10 opens an investment account (IA) with a sponsor 14, also referred to as a brokerage firm. A custodian client account (CCA) is opened at the custodian firm 16. The CMS database 205A associated with the custodian firm 16 is maintained by the CMS 205 as the authority of record for all transactions associated with the IA. The system architecture also includes at least one money manager 20 represented by a MMPMS (not shown), although it will be appreciated that more than one money manager 20 may participate in the present invention, in which case each would be represented by a unique MMPMS.

As also shown in FIG. 5, the system architecture also includes a central reconciliation system (CRS) 215 serving both the sponsor 14 and the money manager 20. Separate reconciliation records are maintained for the sponsor 14 and the money manager 20 by the CRS 215. Sponsor reconciliation records 320 are maintained by the CRS 215, and are accessible by the sponsor 14. Similarly, money manager reconciliation records 325 are maintained by the CRS 215, and are accessible by the money manager 20. Although the sponsor reconciliation records 320 are not associated with the money manager 20, it is possible for the money manager 20 to have access to the sponsor reconciliation records 320. It is also possible for the sponsor 14 to have access to the money manager reconciliation records 325. Both the sponsor reconciliation records 320 and the money manager reconciliation records 325 store data representing the IA. The CRS 215 could be located at the sponsor 14, the money manager 20, or possibly even elsewhere, such as at a service provider (not shown in figures). The CRS 215 is executed by processor 215A which is configured (i.e., programmed) with the logic necessary to perform various functions associated with reconciliation of the two sets of records 320 and 325, to be discussed further below. It should be noted that processor 215A could, as desired, perform other functions. The CMS 205 is executed by processor 205B and is completely distinct from the central reconciliation system 215. As mentioned above, the present invention could also be accomplished by using two separate databases rather than two sets of records stored in a single database. Further, a single database with only one set of records containing different data values for each of the sponsor 14 and the money manager 20 could be used to implement the present invention.

The sponsor reconciliation records 320 and the money manager reconciliation records 325 both store transaction data for the IA as well as business rules to be discussed further below. The sponsor 14 and the money manager 20 are not required to maintain repositories of transaction data. Each of the sponsor 14 and money manager 20 is in communication with the CRS 215 via a communication link. The money manager 20 communicates with the CRS 215 via communication link 250A, and the sponsor 14 communicates with the CRS 215 via communication link 250B.

In the second embodiment of the present invention, a set of records is maintained for each of the sponsor 14 and the money manager 20. Therefore, it is not necessary for the sponsor 14 and money manager 20 to agree to the transaction types to be included in the reconciliation databases 320 and 325 or the type of reconciliation process to be utilized for each included transaction. The central reconciliation system 215, however, can automatically accept a change on behalf of either the sponsor 14 or the money manager 20, in accordance with at least one pre-established rule. For instance, a change may be triggered in the money manager reconciliation records 325 following a reconciliation between the CMS database 205A and the sponsor reconciliation records 320. Similarly, a reconciliation between the CMS database 205A and the money manager reconciliation records 325 may trigger a change in the sponsor reconciliation records 320.

Any reconciliation process performed in either the sponsor reconciliation records 320 or the money manager reconciliation records 325 may be limited to a particular scope or subset of the data received by the CRS 215. In other words, a particular reconciliation may be limited to a particular subset of data by the business rules controlling the reconciliation. For instance, a reconciliation process may be constrained by transaction type, security type, account, grouping of accounts, or a combination of thereof, as defined by the various levels of business rules discussed below.

For ease of explanation, the sponsor reconciliation records 320 will be the first set of records that is reconciled or changed by the central reconciliation system 215 and will be referred to as the first reconciliation records. Accordingly, the money manager reconciliation records 325 will be the second set of records that is changed according to at least one pre-defined business rule and will be referred to as the second reconciliation records. The central reconciliation system 215 may automatically accept a change on behalf of the second reconciliation records following a change in the first reconciliation records. It will be understood by those skilled in the art that the money manager reconciliation records 325 could be the first reconciliation records and the sponsor manager reconciliation records 320 could be the second reconciliation records. A change in the second reconciliation records may be triggered by either automatic or manual reconciliation of a received custodian transaction for the first reconciliation records, or a change may be triggered by some other event. Additionally, a change in the second reconciliation records may be triggered by a change in the first set of records that is not a result of a reconciliation in the first set of records. For example, if a manual non-reconciliation change is made to the first set of records, a change in the second reconciliation records may be triggered.

According to an aspect of the present invention, the second reconciliation records 325 will have a set of business rules that drive the operation of the processor 215A and the central reconciliation system 215. As desired and/or necessary, business rules can be partially, or completely, changed by the parties. As such, the stored business rules are configurable to reflect the change that can be accepted into the second reconciliation records 325. Business rules are preferably stored in association with the second reconciliation records 325; however, as desired, they could be stored elsewhere for access by the processor 215A. The business rules control the acceptance of a proposed modification to the second reconciliation records 325, whether the change be an automatic change or a manual change. The business rules may also control the scope of any reconciliation process that takes place within the central reconciliation system 215. In other words, the business rules may dictate that a particular reconciliation process only applies to a subset of the data in the central reconciliation system 215.

According to an aspect of the present invention, different levels of business rules may be established. For a given reconciliation, there might be one or more business rule associated with a single business rule level, or there might be one or more business rules associated with multiple business rule levels. These levels of business rules may include, in ascending order of precedence, client level business rules, program level business rules, strategy level business rules, style level business rules and account level business rules. An account level business rule applies only to a specific individual MTA. A style level business rule applies to a group of accounts which contain the same mix of assets and are managed by the same money manager 20. A strategy level business rule applies to a group of accounts managed in accordance with the same investment objective by one or more money managers 20. A program level business rule applies to a group of accounts that are associated with a product offering to investors, where the product offering may encompass multiple investment strategies. Finally, a client level business rule applies to all accounts associated with a particular client or sponsor 14 of a money manager 20, where a client may encompass multiple programs. It will be understood that other levels of business rules may be established as necessary and that the precedence order of business rules may be modified. Additionally, a particular business rule may be associated with one or more of the levels described above. A business rule may also be associated with or scoped by a transaction type or by the security involved, as described in further detail below. The transaction type or security may be used in conjunction with a business rule level to define a particular business rule. For instance, a business rule that applies to a “buy” transaction may be defined at a client level. Alternatively, a business rule that applies to IBM stock may be defined at the strategy level.

A client level business rule may be associated with the particular entity, whether it be the sponsor 14 or money manager 20, for whom the system will automatically accept a modification. If a sponsor 14 is associated with more than one money manager 20, each money manager 20 may have different client level business rules established for accepting a change that is made in the sponsor reconciliation records 320. Similarly, the sponsor 14 may have different business rules established for accepting changes made in each of the various money manager reconciliation records 325. Other levels of business rules relate to a particular subset of accounts managed for a client. Groups of accounts may be defined by criteria which include, but are not limited to, “program,” “strategy” or “style.” A program level business rule may apply to a particular investment program that is associated with a product offering to investors. A strategy level business rule may apply to a particular investment strategy associated with an account or group of accounts. A style level business rule may apply to a particular investment style, or a particular mix of assets, associated with a particular program. Additionally, each account maintained by a sponsor 14 or money manager 20 may have business rules associated with it, which will be referred to as account level business rules. As mentioned earlier, more than one business rule may apply for a given reconciliation. If more than one business rule applies to a given reconciliation, the central reconciliation system 215 will perform an automated resolution of any conflicts by ordering the business rules according to precedence. More specifically, a rule applying to an individual account, or account level business rule, will take precedence over a style level business rule; a style level business rule will take precedence over a strategy level business rule; a strategy level business rule will take precedence over a program level business rule, and a program level business rule will take precedence over a client level business rule. If more than one business rule applies to a given reconciliation, the precedence of those rules may be determined and any conflicts resolved according to the hierarchy provided above. It will be understood by those skilled in the art that account business rules can be created relating to any number of criteria and that many different orders of precedence could be established amongst the account business rules.

Business rules may also vary depending on the type of transaction reconciled or modified in the first reconciliation records 320. A business rule may only apply to certain types of transactions. Additionally, a transaction business rule may be scoped to a business rule level such as the client, program, strategy, style or account level. Further, a transaction business rule may be further defined or scoped by the security involved. Also, a business rule relating to a particular security may be scoped by the type of transaction. For example, a particular business rule may only apply to “buy equity” transaction, while another business rule applies to “sell equity” transactions. Yet another business rule may apply to both “buy equity” and “sell equity” transactions. As stated above, the transaction scope of a business rule may apply in combination with a business rule level defined above. A reconciliation may utilize a business rule that combines both a transaction business rule and a business rule level.

Business rules may also vary depending on the security involved in a reconciliation. A separate business rule relating to a security may be used, or the security can further define the scope of another rule, such as a transaction business rule. Additionally, a security business rule may be scoped to a business rule level such as the client, program, strategy, style or account level. For example, a security business rule that applies to any transaction involving IBM may be defined. This security business rule may be scoped by a transaction type such that it applies, for example, to a buy transaction involving IBM. Furthermore, this business rule could be scoped to a particular business rule level such as account, style, strategy, program or client. A single business rule, therefore, may apply to all buy transaction involving IBM that are performed in a particular account.

As with the first embodiment of the present invention, once a reconciliation or alteration has taken place in either the first reconciliation records 320 or the second reconciliation records 325, the reconciliation or alteration may require approval by the entity to be altered (i.e., sponsor 14 or money manager 20) by the reconciliation or alteration. The approval process may determine whether or not an alteration to be made to a database or record is accepted by the entity associated with that database or record. A tolerance level dictates whether data having a value that varies from an expected value by a certain number of units will be automatically approved by the central reconciliation system 215, or held in a pending state until approved by the entity in control of the reconciliation records 325. Tolerance limits may be established in any of multiple unit types including, days, percentage, cost/price, etc. These rules may, as desired, vary according to transaction type or security and may be scoped to a particular business rule level.

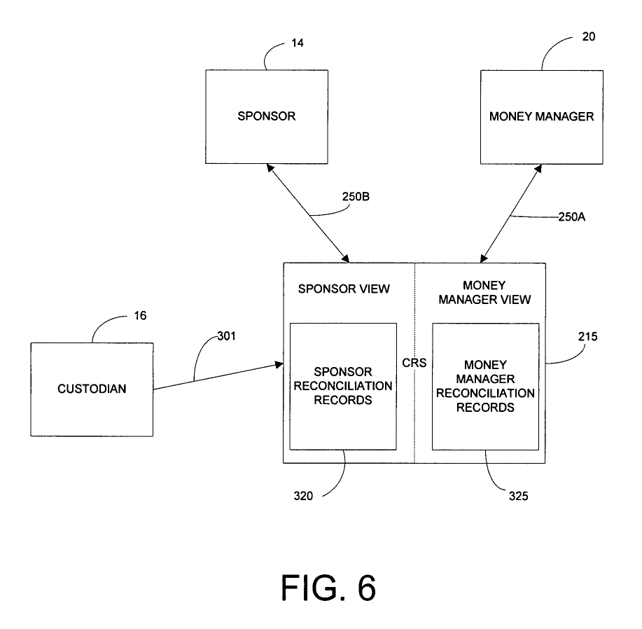

FIG. 6 depicts the movement and storage of portfolio data in accordance with a second illustrative embodiment of the present invention. As shown, the custodian 16 transmits authority data directly to the CRS 215, via communication link 301. The transmission of authority data is periodic and often in the form of batch files. However, as desired, authority data could be transmitted to the CRS 215 on an ad hoc basis and/or in a form other than batch files. The CRS processor 215A executes a reconciliation process with the first reconciliation records 320, which are associated with the sponsor 14 for exemplary purposes in this disclosure. As mentioned earlier, the money manager 20 and the money manager reconciliation records 325 could be the first reconciliation records for purposes of the second embodiment of the present invention. The results of the reconciliation are stored in the first reconciliation records 320 and are immediately available for the first entity. Following modification of the first reconciliation records 320, the second reconciliation records 325 may me modified according to at least one preset business rule.

According to a second embodiment of the present invention, the central reconciliation system 215 maintains an internal set of records for each of the sponsor 14 and the money manager 20. The sponsor reconciliation records 320 are maintained for the sponsor 14, and the sponsor has a view of the sponsor reconciliation records 320 via communication link 250B. The money manager reconciliation records 325 are maintained for the money manager 20, and the money manager has a view of the money manager reconciliation records 325 via communication link 250A. It should be noted that, as desired, the sponsor 14 may be allowed a partial or full view of the money manager reconciliation records 325, and the money manager 20 may be allowed a partial or full view of the sponsor reconciliation records 320. Alternatively, there could be two databases, where the first database is associated with the sponsor 14 and the second database is associated with the money manager 20. It is also possible that one set of records could be maintained with different data fields in that set of records for each of the sponsor 14 and money manager 20.

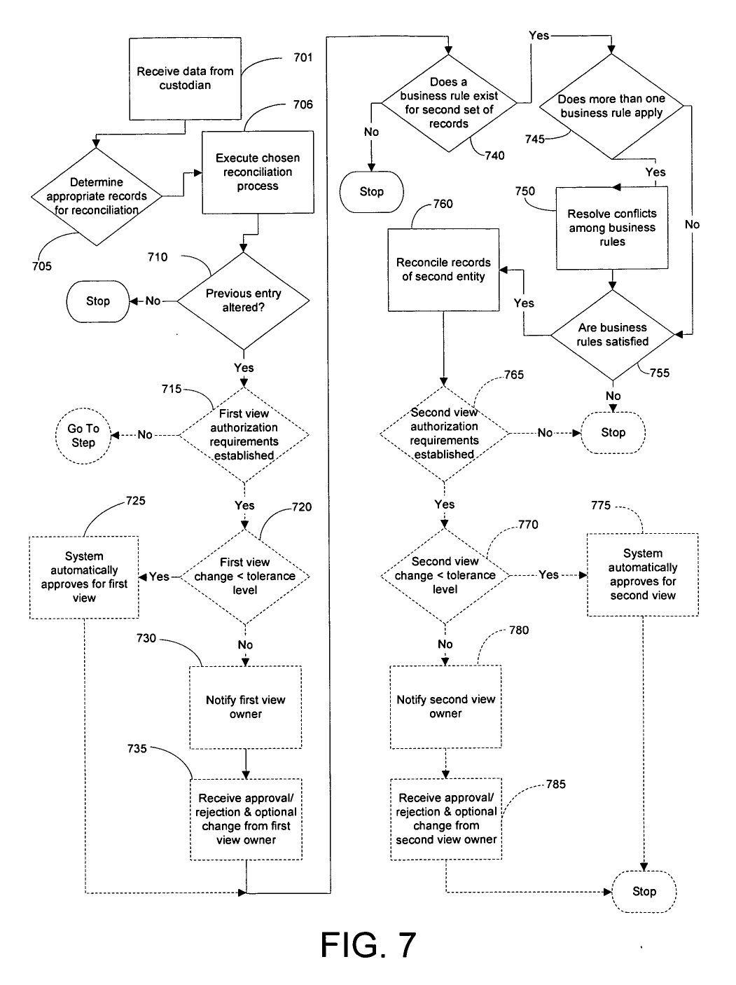

FIG. 7 is a logic diagram depicting the approval portion of the reconciliation process, according to a second embodiment of the present invention. At step 701, the CRS 215 receives authority data from the CMS 205. At step 705, the CRS processor 215A determines the appropriate set of records for reconciliation, i.e., whether the sponsor reconciliation records 320 or the money manager reconciliation records 325 will be the first reconciliation records. Once the first reconciliation records 320 are determined, the CRS processor 215A, at step 706, reconciles the first reconciliation records 320 according to the reconciliation rules associated with the first entity. The first entity may be sent a notification of the reconciliation of the first reconciliation records 320 by electronic means such as e-mail or by non-electronic means such as a letter in the mail. At step 710 the processor 215A determines if authority data previously stored in the first reconciliation records 320 has been altered by the executed reconciliation process. If not, operations stop. If so, operations continue with either step 715 or step 740. As described in further detail below, operations will continue at step 715 if an authorization feature is included in the second embodiment of the present invention and at step 740 if no such authorization feature is included.

As shown by the dotted lines in FIG. 7, the second embodiment of the present invention may require authorization from the first entity before the reconciliation is approved. Steps 715 through 735 perform the authorization from the first entity as was performed in the first embodiment of the present invention. Steps 715 through 735 may be included in the second embodiment of the present invention, but they are not necessary. If approval is not included in an implementation of the present invention, operations would continue at step 740. If, however, authorization is included, operations would continue at step 715. At step 715, the processor 215A determines if any authorization requirements have been established by the first entity, which is the sponsor 14 for purposes of this explanation. That is, the processor 215A determines if any authorization requirement rules are stored. If the determination of step 715 is negative, operations continue at step 740.

If it is determined in step 715 that authorization rules have been established, operations continue with step 720 in which the processor 215A uses the retrieved first entity 14 established tolerance rule to determine if the alteration is less than the established tolerance level. If so, operations continue with step 725 in which the processor 215A automatically approves the alteration for the first entity 14. Operations then continue with step 740, to be discussed below.

If at step 720 it is determined that the alteration exceeds the established tolerance level, operations continue with step 730 in which the first entity 14 is notified of the alteration. At step 735, following step 720, the processor 215A receives from the first entity 14 either an approval or rejection of the alteration.

Following step 735 operations continue with step 740. Alternatively, if there is no approval feature included in the second embodiment of the present invention, step 740 would have been reached following step 710. At step 740, the processor 215A determines whether or not the second reconciliation records 325 have any business rules associated with the automatic acceptance of a change made to the first reconciliation records 320 for the particular transaction at hand. If the second reconciliation records 325 do not have any business rules associated with the automatic acceptance or automatic inheritance of changes made to the first reconciliation records 320, then operations cease. On the other hand, if the second reconciliation records 325 have business rules associated with automatic acceptance of changes made to the first reconciliation records 320 for the transaction at hand, then the second reconciliation records 325 will be reconciled with any alterations that were made to the first reconciliation records 320. If business rules are located at step 740, the processor 215A next determines at step 745 whether more than one business rule applies to the automatic acceptance of the transaction at hand. If only one business rule applies, operations continue with step 755. If, however, more than one business rule applies to the transaction, then the processor 215A resolves any conflicts between the business rules at step 750. At step 750, there may or may not be any conflicts between multiple business rules. For example, it may be possible to implement two business rules simultaneously. If, however, conflicts do exist among business rules, those conflicts are resolved by prioritizing the various business rules. As discussed above, many different prioritizations could be implemented by the present invention; however, in the present example, the levels of priority are: (1) account level business rules; (2) style level business rules; (3) strategy level business rules; (4) program level business rules; and (5) client level business rules. Each of these levels of business rules may be scoped by the type of transaction or the security involved. Additionally, transaction business rules or security business rules may be present that are not scoped to any particular business rule level. In such a situation, they may receive lower priority than any business rule that is scoped to or associated with a business rule level. If two business rules conflict, the business rule with the higher priority will be maintained while the lower priority rule may be discarded to the extent that it conflicts with the higher priority rule. After conflicts in the business rules have been resolved at step 750, operations will continue at step 755.

At step 755, the processor 215A determines whether or not the business rules have been satisfied. If the business rules have not been satisfied, then operations cease and the second reconciliation records 235 are not altered. At this point, if there is no automatic acceptance of the changes made to the first entity, a reconciliation process specific to the second entity could be executed. If, however, the business rules are satisfied at step 755, then the second reconciliation records 235 are reconciled to the first reconciliation records 230. At this point, operations may cease or continue with an authorization process associated with the second entity 20.

The alterations made to the second reconciliation records may relate to any aspect of an investment transaction. These aspects include, but are not limited to, the share price of a security, the total monetary value of a security transaction, the total number of shares involved in a security transaction, the date on which a security transaction took place, and the time at which a security transaction took place. It will be understood by those of ordinary skill in the art that other aspects of an investment transaction may also be automatically altered according to business rules associated with the second reconciliation records 325.

Following reconciliation of the second reconciliation records 325, and particularly when not automatically inherited from reconciliation on behalf of the first entity, the second embodiment of the present invention may also include an authorization process in which the second entity 20 may approve or reject a reconciliation. If an authorization process is not included in the second embodiment of the present invention, then operations will cease following step 760. If, however, an authorization process, is included, operations will continue with step 765 in which the processor 215A determines whether there are any authorization rules established by the second entity 20. If the determination of step 765 is negative, operations stop.

If it is determined in step 765 that authorization rules have been established, operations continue with step 770 in which the processor 215A uses the retrieved second entity 14 established tolerance rule to determine if the alteration is less than the established tolerance level. If so, operations continue with step 775 in which the processor 215A automatically approves the alteration for the second entity 20. Operations then stop.

If at step 770 it is determined that the alteration exceeds the established tolerance level, operations continue with step 780 in which the second entity 20 is notified of the alteration. At step 785, following step 780, the processor 215A receives from the second entity 20 either an approval or rejection of the alteration. Then, operations cease.

Automatic acceptance of a modification by the second entity 20 according to the established business rules results in the proposed modification being reflected in the second reconciliation records 325 associated with the second entity 20. For tracking purposes, an indicator that an automatic modification has occurred can be stored in the CRS 215 by the CRS process 215A. The second entity 20 may also be notified of the automatic acceptance. This notification can be accomplished through a message sent via communication link 250A. Optionally, the notification of the second entity 20 may be accomplished through other forms of electronic communication including e-mail or an “in application” messaging function, or the notification may be accomplished through non-electronic communication. Additionally, if the modification is the result of a reconciliation performed for another entity, that entity may be notified of the acceptance by the second entity 20, the CRS 215, or some other entity. Here, the first entity 14 could be notified of the acceptance of the modification to the first reconciliation records 320 by the second entity 20 and the second reconciliation records 325.

As an example of the technique provided by the second embodiment of the present invention, the reconciliation of a “buy equity” transaction will be examined. In this example, the sponsor 14 is the first entity and a reconcile-and-post reconciliation process will be used by the sponsor 14 for the particular transaction. The money manager 20 is the second entity and it has a set of business rules established for automatically accepting changes to its database based on changes made to the first reconciliation records 320. The sponsor 14 establishes a threshold level of $5.00 for “buy equity” transactions at an account level, meaning the sponsor 14 will automatically accept a change occurring during a reconciliation between the CRS 215 and the first reconciliation records 320 for the particular account involved here if the change in transaction price per share is within +/−$5.00 of the price per share already stored in the first reconciliation records 320. The money manager 20 allows automatic acceptance or reconciliation of a change in a “buy equity” transaction at a client level (with the sponsor 14 being the client) if the proposed share price is within $1.00 of the internal share price stored in the second reconciliation database 325.

The money manager 20 orders a purchase of 100 shares of IBM stock at $90.00/share. The money manager 20 transmits this information to the CRS 215 and the attention of the sponsor 14. Processor 215A causes this information to be stored in both the first reconciliation records 320 and second reconciliation records 325. When executed, 99 shares of IBM at $89.95/share are actually purchased. The CMS 205 transmits authority data reflecting the actual trade to the CRS 215.

At some point after receipt of the authority data, the processor 215A executes the reconcile-and-post process (as the chosen preference). As a result of this processing, the prior “buy 100 shares of IBM at $90.00/share” is replaced with “buy 99 shares of IBM at $89.95/share”. The processor 215A determines, based upon the stored authorization rules, that the sponsor 14 must approve a change to the prior entry. The processor 215A accesses the stored tolerance level of the sponsor 14 to determine if an automatic system approval of the alteration can be made. Because the change does not exceed the stored threshold, the processor 215A automatically changes the first reconciliation records 320 to reflect the change.

After the change is made to the first reconciliation records 320, the processor 215A determines whether a change can be automatically made to the second reconciliation records 325 on behalf of a second entity, the money manager 20 according to business rules associated with the second entity 20 for the particular transaction. The processor 215A determines that business rules are established by the money manager 20 in order to allow the central reconciliation system 215 to automatically accept changes to the second reconciliation records 325 on behalf of the money manager 20. In other words, the processor 215A can reconcile the second reconciliation records 325 to the first reconciliation records 320 if the business rules established for the particular transaction are satisfied. In this situation, there is a business rule associated with “buy equity” transactions in which a change will be automatically accepted if the proposed share price is within $1.00 of the internal share price stored in the second reconciliation records 325. Here, the proposed share price is $89.95 per share and the internal share price stored in the second reconciliation records 325 is $90.00 per share. The proposed share price satisfies the business rule so the second reconciliation records 325 are automatically reconciled to the first reconciliation records 320 and reflect the purchase of the 99 shares of IBM stock by the sponsor 14. An authorization procedure using tolerance rules could also be performed following the reconciliation of the second reconciliation records 320, but it is not necessary.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for approval of a alteration of an investment account transaction, comprising:
storing, in an investment account data repository accessible by a first entity and a second entity, a first record of a transaction associated with the first entity;
storing, in the investment account data repository, a second record of the transaction associated with the second entity;
applying an alteration to the first record;
identifying a rule for altering the second record based on the alteration of the first record; and
if the rule is determined to be satisfied, altering the second record to conform to the alteration of the first record.

2. The method of claim 1, wherein:
the first entity is a sponsor of an investor with whom the investment account is associated; and
the second entity is a money manager that directs the transacting of at least a portion of the investment account.

3. The method of claim 1, wherein:
the first entity is a money manager that directs the transacting of at least a portion of the investment account; and
the second entity is a sponsor of an investor with whom the investment account is associated.

4. The method of claim 1, further comprising:
receiving, from a third entity, a third record associated with the investment account transaction; and
reconciling the received third record with the first record;
wherein the alteration of the first record is a consequence of the reconciling of the received record with the first record.

5. The method of claim 4, wherein the third entity is a custodian that maintains the authority book of record for the investment account.

6. The method of claim 4, wherein reconciling the received third record with the stored first record includes executing one of (i) a post only reconciliation process, (ii) a reconcile only reconciliation process, (iii) a reconcile and post reconciliation process, (iv) a reconcile and adjust reconciliation process, (v) an ignore reconciliation process, and (vi) a pend reconciliation process.

7. The method of claim 1, wherein the alteration of the second record for an investment account transaction is to one of: a share price of a security, a total monetary value of a security transaction, a total number of shares involved in a security transaction, a date on which a security transaction occurred, and a time at which a security transaction occurred.

8. The method of claim 1, wherein identifying the rule involves selecting from among more than one of a plurality of rules based on prioritization of the plurality of rules.

9. The method of claim 1, wherein an indicator of the altering of the second record to conform to the first record is stored.

10. The method of claim 1, wherein at least one of the first entity and the second entity is notified as to the alteration of the second record to conform to the first record.

11. The method of claim 1, wherein the rule is associated with at least one of (i) an entity associated with the second record, (ii) a transaction type of the investment account transaction, (iii) a security involved in the investment account transaction, and (iv) one or more investment accounts.

12. A method for performing automatic acceptance of an alteration of an investment account transaction, comprising:
making alterations to a first view of the investment account transaction; and
updating a second view of the investment account transaction to reflect the alterations made to the first view if an applicable rule is satisfied;
wherein the applicable rule controls the automatic acceptance by the second view of alterations made to the first view.

13. The method of claim 12, wherein:
the first view of the investment account transaction is associated with a sponsor of an investor with whom the investment account is associated; and
the second view of the investment account transaction is associated with a money manager that directs the transacting of at least a portion of the investment account.

14. The method of claim 12, wherein:
the first view of the investment account transaction is associated with a money manager that directs the transacting of at least a portion of the investment account; and
the second view of the investment account transaction is associated with a sponsor of an investor with whom the investment account is associated.

15. The method of claim 12, further comprising:
receiving authority data relating to the investment account transaction; and
making alterations to the first view of the investment account transaction based on the received authority data.

16. The method of claim 15, wherein the authority data is received from a custodian that maintains the authority book of record for the investment account.

17. The method of claim 16, wherein making alterations to the first view of the investment account transaction based on the received authority data includes executing one of (i) a post only reconciliation process, (ii) a reconcile only reconciliation process, (iii) a reconcile and post reconciliation process, (iv) a reconcile and adjust reconciliation process, (v) an ignore reconciliation process, and (vi) a pend reconciliation process.

18. The method of claim 12, wherein updating the second view of the investment account transaction involves updating one of: a share price of a security, a total monetary value of a security transaction, a total number of shares involved in a security transaction, a date on which a security transaction occurred, and a time at which a security transaction occurred.

19. The method of claim 12, wherein the applicable rule is selected from among more than one of a plurality of applicable rules based on relative prioritization of the plurality of applicable rules.

20. The method of claim 12, wherein an indicator of the updating of the second view of the investment account transaction is stored.

21. The method of claim 12, wherein a notification of the updating of the second view of the investment account transaction is sent to one of an entity associated with the first view of the investment account transaction or an entity associated with the second view of the investment account transaction.

22. The method of claim 12, wherein the applicable rule is associated with at least one of (i) an entity associated with the second view of the investment account transaction, (ii) a transaction type of the investment account transaction, (iii) a security involved in the investment account transaction, and (iv) one or more investment accounts.

23. A system for performing automatic acceptance of an alteration of an investment account transaction, comprising:
a memory configured to store a first view of an investment account transaction, a second view of an investment account transaction, and one or more rules associated with automatic acceptance of an alteration to the first view for the second view.
a processor in communication with the memory and including program logic that performs the following steps:
altering the first view of the investment account transaction; and
updating the second view of the investment account transaction to reflect the alterations made to the first view if the one or more rules are satisfied.

24. The system of claim 23, wherein:
the first view of the investment account transaction is associated with a sponsor of an investor with whom the investment account is associated; and
the second view of the investment account transaction is associated with a money manager that directs the transacting of at least a portion of the investment account.

25. The system of claim 23, wherein:
the first view of the investment account transaction is associated with a money manager that directs the transacting of at least a portion of the investment account; and
the second view of the investment account transaction is associated with a sponsor of an investor with whom the investment account is associated.

26. The system of claim 23, wherein the processor is further configured to receive authority data relating to the investment account transaction and alter the first view of the investment account transaction based on the received authority data.

27. The system of claim 26, wherein the authority data is received from a custodian that maintains the authority book of record for the investment account.

28. The system of claim 26, wherein the altering of the first view of the investment account transaction based on the received authority data includes executing one of (i) a post only reconciliation process, (ii) a reconcile only reconciliation process, (iii) a reconcile and post reconciliation process, (iv) a reconcile and adjust reconciliation process, (v) an ignore reconciliation process, and (vi) a pend reconciliation process.

29. The system of claim 23, wherein updating the second view of the investment account transaction involves updating one of: a share price of a security, a total monetary value of a security transaction, a total number of shares involved in a security transaction, a date on which a security transaction occurred, and a time at which a security transaction occurred.

30. The system of claim 23, wherein the one or more rules are selected from a plurality of rules based on relative prioritization of the plurality of rules.

31. The system of claim 23, wherein the processor stores an indicator of the updating of second view of the investment account transaction in the memory.

32. The system of claim 23, wherein the processor sends a notification of the updating of second view of the investment account transaction to one of an entity associated with the view of the investment account transaction or an entity associated with the second view of the investment account transaction.
